(19) United States
(12) Patent Application Publication
(10) Pub. No.: US 2023/0145475 A1
(43) Pub. Date: May 11, 2023

(54) HYBRID WIND POWER SYSTEM

(71) Applicant: FOI GROUP, LLC, Dallas, TX (US)

(72) Inventor: DAVID MUNSON, JR., Dallas, TX (US)

(21) Appl. No.: 17/984,951

(22) Filed: Nov. 10, 2022

Related U.S. Application Data
(60) Provisional application No. 63/278,386, filed on Nov. 11, 2021.

(51) Int. Cl. F03D 9/28; F03D 9/25; F03D 9/17; F03D 9/00

(52) U.S. Cl. CPC F03D 9/28; F03D 9/25; F03D 9/17; F03D 9/007; F05B 2220/706

(57) ABSTRACT

Hybrid power system utilizes wind powered compression for operation of expansion turbine. The hybrid power system includes at least one wind turbine that produces mechanical power, a compressor unit that compresses air, and an expansion turbine that receives the compressed air from the compressor unit and produces power to operate an alternator or a generator that produces electricity. The compressor unit includes one or more compressors coupled to the at least one wind turbine to compress air and may optionally include at least one intercooling device configured to cool the air compressed by the compressors. The hybrid power system may optionally include one or more heating devices configured to heat the compressed air flowing from the compressor unit to the expansion turbine.

### CROSS REFERENCE TO RELATED APPLICATIONS

This application claims the priority of U.S. Provisional Application Ser. No. 63/278,386, filed on Nov. 11, 2021, which is incorporated herein by reference in its entirety.

### BACKGROUND

Using vertical axis wind turbines means the power conversion equipment is on the ground rather than high in the air on a nacelle that rotates so that a horizontal axis turbines blades are perpendicular to the wind. A vertical axis wind turbine can handle shifting wind easily and operate in a wider range of wind speeds. As stated before there is a strong bias with designers to seek as large a turbine as possible pushing the limits of materials. The swept area of a horizontal axis wind turbine goes up dramatically as the square of the radius so bigger definitely makes more power per length of blade. There are tradeoffs though with stresses on mechanism and increased danger to flying creatures. The longer the blades of a horizontal axis wind turbine are the faster the tip moves creating more danger for flying animals.

### SUMMARY

In order to overcome the drawbacks of the conventional system, the hybrid power system of the disclosed invention is constructed to use the wind in a different way not as a standalone power source for fluctuating electric power but as part of an integrated gas turbine power system that produced stable power in all wind conditions.

These advantages may be achieved by a hybrid power system that includes one or more wind turbines that produce power, a compressor unit including one or more compressors coupled to the one or more wind turbines, and an expansion turbine that receives the compressed air from the compressor unit and produces power to operate an alternator or a generator that produces electricity. The one or more compressors are configured to compress air and are operated by the power produced by the wind turbines.

The one or more wind turbines may include one or more vertical axis wind turbines. The one or more vertical axis wind turbines may be respectively connected to the one or more compressors to operate the one or more compressors. The one or more wind turbines may be configured to mechanically drive the compressors. The compressor unit may further include a fuel powered extra compressor to compress air. The compressor unit may further include at least one intercooling device configured to cool the air compressed by the compressors. The hybrid power system may further include one or more heating devices configured to heat the compressed air flowing from the compressor unit to the expansion turbine.

These advantages may also be achieved by a hybrid power system that includes at least one renewable power system that is configured to produce electrical power, at least one motor driven by the electrical power provided by the renewable power system, a compressor unit including one or more compressors configured to compress air where the compressors are operated by the motor, and an expansion turbine that receives the compressed air from the compressor unit and produces power to operate an alternator or a generator that produces electricity.

### BRIEF DESCRIPTION OF THE DRAWINGS

The preferred embodiments described herein and illustrated by the drawings hereinafter be to illustrate and not to limit the invention, where like designations denote like elements.

FIG. 1 is a diagram illustrating hybrid gas turbine system that utilizes wind powered compression for operation of expansion turbine.

FIG. 2 is a diagram illustrating hybrid gas turbine system that utilizes indirect wind or solar powered compression for operation of expansion turbine.

### DETAILED DESCRIPTION

In this section, some embodiments of the invention will be described more fully with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments. Parts that are the same or similar in the drawings have the same numbers and descriptions are usually not repeated.

A gas turbine works by compressing air to a high pressure and then heating it to expand its volume before it is run through an expansion power producing stage. Typically a standard gas turbine uses about half the power produced by the expansion stage to power the air compressor. Wind power varies by the third power of the wind speed, which means that there is a wide variation in power with very high power output in higher winds. In the disclosed invention, a new design hybrid gas turbine system integrated with vertical axis wind turbines is proposed.

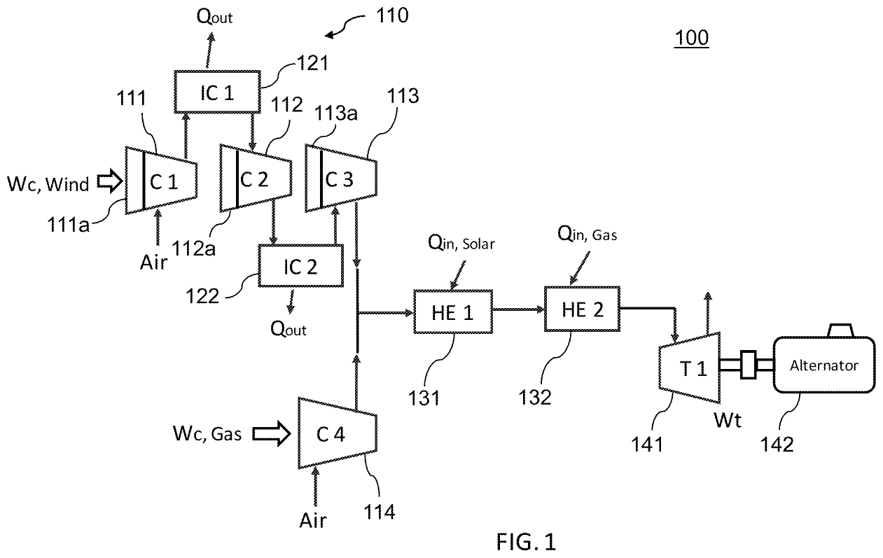

With reference to FIG. 1, shown is a diagram illustrating hybrid power system 100 that utilizes wind powered compression for operation of expansion turbine. The hybrid power system 100 includes one or more wind turbines 111a, 112a, 113a, compressor unit 110, and expansion turbine 141. The compressor unit 110 includes one or more compressors 111, 112, 113 and at least one intercooling device 121, 122 connected between the compressors 111, 112, 113. The wind turbines 111a, 112a, 113a are configured to mechanically drive the compressors 111, 112, 113 by wind power. The compressor unit 110 may further include at least one extra compressor 114 that may be operated in times of little or no wind. The extra compressor 114 may be operated by gas or fuel powered engines or electric power, while the compressors 111, 112, 113 are driven by the wind turbines 111a, 112a, 113a. The wind turbines 111a, 112a, 113a may be vertical axis wind turbines.

The compressors 111, 112, 113 may be integrated with or mechanically coupled to vertical axis wind turbines 111a, 112a, 113a, respectively, to mechanically drive the compressors. However, a single vertical axis wind turbine may be mechanically coupled to the multiple compressors to provide mechanical power to drive the compressors. FIG. 1 exemplarily shows three compressors 111, 112, 113 connected in series and three vertical axis wind turbines 111a, 112a, 113a, but the numbers of compressors and vertical axis wind turbines are not limited to three. Any numbers of compressors and vertical axis wind turbines may be employed for the hybrid power system 100.

The hybrid power system 100 further includes heating stages (or devices) 131, 132 placed between the compressor unit 110 and expansion turbine 141 to heat the compressed air supplied from the compressor unit 110 before entering the expansion turbine 141. Alternator (or generator) 142 is driven by the expansion turbine 141 and generates electricity.

While the compressed air is supplied from the compressor unit 110 to the expansion turbine 141, the compressed air may be heated by the heating stages 131, 132 before entering the expansion turbine 141. In periods of high wind speed, operations of the heating stages 131, 132 may be stopped as there would be so much compressed air to fully supply the expansion turbine 141 that is driving a power alternator 142 to make high quality power. In times of average or lower than average wind speed, the compressed air supplied from the compressor unit 110 may be heated by the heating stages 131, 132 to make much more compressed air power than the wind power by itself, because when high compressed air is supplied, the gas turbine 141 makes twice as much power as the compression stage. The hybrid power system 100 combines wind power with heat supplied by heating stages 131, 132 for a steadier full time electric generation. Having extra compressors 114 available on standby, the hybrid power system 100 is allowed to make power in times of inadequate or no wind. FIG. 1 exemplarily show solar heating stage 131 and natural gas or fuel powered heating stage 132. However, different types and different numbers of heating stages can be employed for the hybrid power system 100.

Current gas expansion turbines compress air without intercooling to a low pressure ratio so as not to heat the air to a high temperature which would limit the air expansion when fuel is combusted to heat it. Because of the relatively low pressure, the expansion turbine doesn't extract much work from the gas and the exhaust is at a very high temperature. The hybrid power system 100 further includes intercooling devices 121, 122 connected between the compressors 111, 112, 113 to cool the compressed air supplied by the compressors. The intercooling devices 121, 122 may be heat exchangers that transfer heat from the compressed air to atmosphere. With intercooling between multiple compression stages a much higher pressure ratio can be achieved for much more power extraction from the power producing expansion stage of the expansion turbine 141. One thing else that can be done before the final compression stage of the expansion turbine 141 is to humidify the supplied air with water misters, for example, to near 100% humidity for increased power output as water vapor is an excellent power generating gas.

While a vertical axis wind turbine can make power from any direction of wind, additional power may be gained by putting vertical axis wind turbine on top of an elevated platform that can rotate to align with the wind, equipped with a wind directing sloped surface to concentrate wind from below the turbine onto the turbine. This simulates the desirable situation of a wind turbine being at the crest of a hill or ridge. If the platform is mounted on a circular track, then its large radius makes it easy to build large vertical axis turbines without deep concrete foundations as horizontal axis turbines use. For the safety of the birds and other flying creatures, it may not be necessary to build massive numbers of horizontal wind turbines that don't produce reliable power.

The current horizontal axis wind turbine is ever larger turbines and a massive number of turbines often in areas far from energy use. There are major issues with producing good quality power. The hybrid power system 100 of the disclosed invention prevents these issues by employing vertical axis wind turbines. The hybrid power system 100 has the ability to provide needed power on demand which is critical and impossible with conventional wind turbines which operate at a fraction of nameplate capacity on average with huge variation in power as wind power goes up by the third power of wind speed. Putting vertical axis wind turbines on or near energy loads makes a lot of sense but requires a change of thinking away from the utility mindset of large remote power plants connected to needs by long distance power grid. However, even though the hybrid power system 100 of the disclosed invention prefers vertical axis wind turbines, the disclosed invention does not completely exclude using horizontal axis wind turbine, because any types of wind turbine has the capability to mechanically operate the compressors. For example, based on geographical conditions, horizontal axis wind turbines, or in combination with vertical axis wind turbines, may be employed to mechanically operate the compressors.

Wind Powered Compression for Brayton Power Cycle

As shown in FIG. 1, one or more vertical axis wind turbines 111a, 112a, 113a are driven by wind power, and provide input power to drive compressors 111, 112 and 113 either as a single turbine or a series of turbines each powering one compressor. Air entered into the first compressor 111 is compressed by the first compressor 111 and further compressed by the second and third compressors 112, 113. The intercooling devices 121 and 122 between compressors 111, 112 and 113 maximize pressure ratio by cooling the compressed air supplied by the compressors 111, 112 and 113. In times of little or no wind, the natural gas or fuel powered extra compressor 114 may provide the needed compressed air to make power. The compressed air is supplied to the expansion turbine 141.

Depending on the amount of wind power that drives the wind turbines 111a, 112a, 113a, the solar thermal heating stage 131 and/or natural gas heating stage 132 may be turned on to heat the compressed air flowing from the compressor unit 110 to the expansion turbine 141 to expand the compressed gas for more power output. In high wind conditions, enough compressed air may be created not to need the air heating before expansion in expansion turbine 141. In this case, the solar thermal heating stage 131 and/or natural gas heating stage 132 may be turned off. In this way, the hybrid power system 100 provides added advantages of rotary inertia with the expansion turbine 141 and alternator (or generator) 142 stabilizing electric power output. Compressed air storage (not shown) may also be added to stabilize system.

Indirect Wind or Solar Power Compression for Brayton Power Cycle

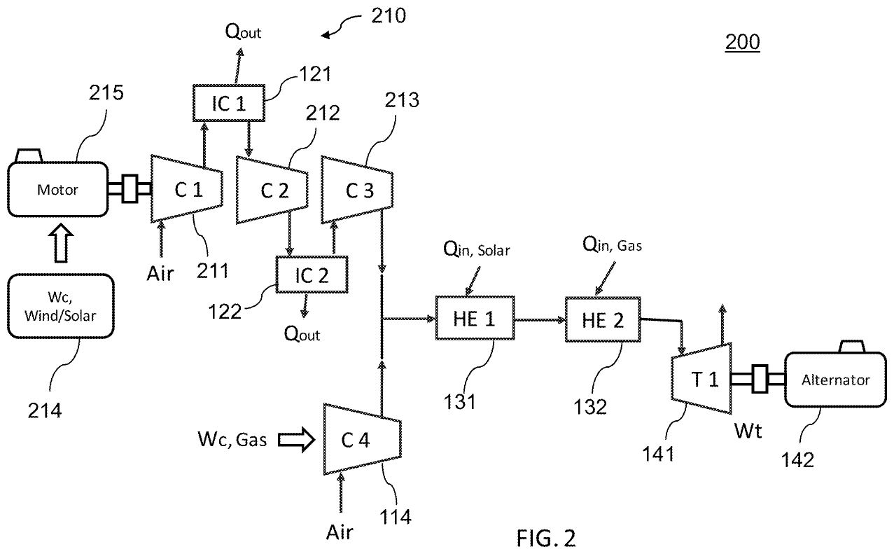

With reference to FIG. 2, shown is a diagram illustrating hybrid power system 200 that utilizes indirect wind or solar powered compression for operation of expansion turbine. In this embodiment, wind power or solar power system 214 is used to make electricity to drive an electric motor 215 that derives compressors 211, 212, 213 of compressor unit 210 to provide compressed air to an expansion turbine 141. If wind power is used for the power system 214, the power system 214 may include vertical axis wind turbines and/or horizontal axis wind turbines. Any renewable power systems such as wind power system and solar power system may be used for the power system 214.

Air entered into the first compressor 211 is compressed by the first compressor 211 and further compressed by the second and third compressors 212, 213. The intercooling devices 121 and 122 between compressors 211, 212 and 213 maximize pressure ratio by cooling the compressed air supplied by the compressors 211, 212 and 213. If power output by the power system 214 is not enough to produce required air compression, the natural gas or fuel powered extra compressor 114 may provide the needed compressed air to make power. The compressed air is supplied to the expansion turbine 141.

Depending on the power produced by the power system 214, the solar thermal heating stage 131 and/or natural gas heating stage 132 may be turned on to heat the compressed air flowing from the compressor unit 210 to the expansion turbine 141 to expand the compressed gas for more power output. When enough compressed air is created by the compressor unit 210 not to need the air heating before expansion in expansion turbine 141, the solar thermal heating stage 131 and/or natural gas heating stage 132 may be turned off. The hybrid power system 200 in this embodiment allows horizontal axis wind turbines to be used and offers stable power in frequency and voltage. It is possible to use solar energy to provide electricity for the compression as well also stabilizing it. Providing natural gas or fuel powered compressor 114 as a backup makes the system more reliable.

Since many modifications, variations, and changes in detail can be made to the described preferred embodiments of the invention, it is intended that all matters in the foregoing description and shown in the accompanying drawings be interpreted as illustrative and not in a limiting sense. Consequently, the scope of the invention should be determined by the appended claims and their legal equivalents.

What is claimed is:

1. A hybrid power system, comprising:
one or more wind turbines that produce power;
a compressor unit comprising one or more compressors coupled to the one or more wind turbines, wherein the compressors are configured to compress air and are operated by the power produced by the wind turbines; and
an expansion turbine that receives the compressed air from the compressor unit and produces power to operate an alternator or a generator that produces electricity.

2. The hybrid power system of claim 1 wherein the one or more wind turbines include one or more vertical axis wind turbines.

3. The hybrid power system of claim 2 wherein the one or more vertical axis wind turbines are respectively connected to the one or more compressors to operate the one or more compressors.

4. The hybrid power system of claim 2 wherein the one or more wind turbines are configured to mechanically drive the compressors.

5. The hybrid power system of claim 1 wherein the compressor unit further comprises an extra compressor to compress air, wherein the extra compressor is configured to supply compressed air to the expansion turbine when necessary.

6. The hybrid power system of claim 5 wherein the extra compressor is driven by a fuel powered engine or electric power.

7. The hybrid power system of claim 1 wherein the compressor unit further comprises at least one intercooling device configured to cool the air compressed by the compressors.

8. The hybrid power system of claim 7 wherein the at least one intercooling device is connected between the compressors to cool the compressed air flowing between the compressors.

9. The hybrid power system of claim 1 further comprising one or more heating devices configured to heat the compressed air flowing from the compressor unit to the expansion turbine.

10. The hybrid power system of claim 9 wherein the one or more heating devices includes a solar thermal heating device and/or a fuel powered heating device.

11. A hybrid power system, comprising:
at least one renewable power system that is configured to produce electrical power;
at least one motor driven by the electrical power provided by the renewable power system;
a compressor unit comprising one or more compressors configured to compress air, wherein the compressors are operated by the motor; and
an expansion turbine that receives the compressed air from the compressor unit and produces power to operate an alternator or a generator that produces electricity.

12. The hybrid power system of claim 11 wherein the renewable power system comprised a wind turbine system and/or a solar power system.

13. The hybrid power system of claim 12 wherein the wind turbine system comprises a vertical axis wind turbine and/or a horizontal axis wind turbine.

14. The hybrid power system of claim 11 wherein the compressor unit further comprises an extra compressor to compress air, wherein the extra compressor is configured to supply compressed air to the expansion turbine when necessary.

15. The hybrid power system of claim 14 wherein the extra compressor is driven by a fuel powered engine or electric power.

16. The hybrid power system of claim 11 wherein a compressor unit further comprises at least one intercooling device configured to cool the air compressed by the compressors.

17. The hybrid power system of claim 16 wherein the at least one intercooling device is connected between the compressors to cool the compressed air flowing between the compressors.

18. The hybrid power system of claim 11 further comprising one or more heating devices configured to heat the compressed air flowing from the compressor unit to the expansion turbine.

19. The hybrid power system of claim 18 wherein the one or more heating devices includes a solar thermal heating device and/or a fuel powered heating device.
